(19) United States
(12) Patent Application Publication
(10) Pub. No.: US 2011/0261370 A1
(43) Pub. Date: Oct. 27, 2011

(54) OPTICAL SENSOR FOR PROXIMITY AND COLOR DETECTION

(75) Inventors: Philip Floyd, Redwood City, CA (US); Tsongming Kao, Sunnyvale, CA (US); Marc Mignard, San Jose, CA (US); Suryaprakash Ganti, Los Altos, CA (US); Manish Kothari, Cupertino, CA (US)

(73) Assignee: QUALCOMM MEMS Technologies, Inc., San Diego, CA (US)

(21) Appl. No.: 13/047,180

(22) Filed: Mar. 14, 2011

Related U.S. Application Data
(60) Provisional application No. 61/326,846, filed on Apr. 22, 2010.

(51) Int. Cl. G01B 11/14; G01J 3/46; G01J 3/50

(52) U.S. Cl. 356/614; 250/226; 356/402

(57) ABSTRACT

This disclosure provides systems, methods and apparatus, including computer programs encoded on computer storage media, for detecting proximity and/or color of an object. In one aspect, an optical sensor includes a plurality of transmissive interferometric elements, a plurality of detectors positioned to detect the presence and/or intensity of light transmitted through the elements, and a processor to determine the proximity of an object based at least in part upon input from the detectors. An optical signal can be sensed by selectively actuating certain elements in a set of transmissive interferometric elements in an array to allow transmission of optical signals within a first spectrum through the array, and detecting optical signals transmitted through the array.

### CROSS-REFERENCE TO RELATED APPLICATIONS

This disclosure claims priority to U.S. Provisional Patent Application No. 61/326,846, filed Apr. 22, 2010, entitled “Optical Sensor for Proximity and Color Detection,” and assigned to the assignee hereof. The disclosure of the prior application is considered part of, and is incorporated by reference in, this disclosure.

### TECHNICAL FIELD

This disclosure relates to optical sensors for use with display devices.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented as an optical sensing device including a first substrate, a second substrate opposing the front substrate, at least one transmissive interferometric element formed on the first substrate, the transmissive interferometric element being actuatable (i.e., capable of being actuated) to allow or prevent passage of optical signals within at least a first transmission spectrum through to the second substrate, and at least one optical detector formed on the second substrate, the optical detector positioned to detect optical signals passed through the transmissive interferometric element. The transmissive interferometric element can include a partially transmissive fixed layer and a partially transmissive movable layer. The transmissive interferometric element can be configured to allow passage of optical signals within the first transmission spectrum when the transmissive interferometric element is in an unactuated state. The device can include a plurality of transmissive interferometric elements. The plurality of transmissive interferometric elements can include at least one transmissive interferometric element that is actuatable to allow or prevent passage of optical signals within a second transmission spectrum through to the second substrate. The transmissive interferometric elements can be independently actuatable. The device can include a plurality of optical detectors formed on the second substrate. Each of the optical detectors can be configured to receive optical signals passed through a single transmissive interferometric element. In some implementations, at least one of the optical detectors can be configured to receive optical signals passed through more than one of the transmissive interferometric elements. The device can include an array of reflective interferometric elements formed on the first substrate, the array of reflective interferometric elements being configured to produce a display. Each of the reflective interferometric elements can include a partially transmissive fixed layer and a reflective movable layer. The transmissive interferometric elements can be dispersed throughout the array of reflective interferometric elements. In some implementations, the transmissive interferometric elements can be positioned apart from the array of reflective interferometric elements. The device can include a processor configured to determine proximity of an object to the sensing device based at least in part upon input from the optical detector. In some implementations, the device can include a processor configured to determine the color of an object based at least in part upon input from the optical detector. The device also can include a light guide disposed on the first substrate.

In another implementation, an optical sensing device includes a first substrate, a second substrate opposing the front substrate, means for selectively allowing or preventing passage of optical signals within at least a first transmission spectrum through the first substrate toward the second substrate, and means for detecting the presence or intensity of the first spectrum on the second substrate. The device also can include means for selectively allowing or preventing passage of optical signals within at least a second transmission spectrum through the first substrate toward the second substrate.

In another implementation, a method includes forming a transmissive interferometric element on a first substrate, the interferometric element being actuatable to allow or prevent passage of optical signals within at least a first transmission spectrum, separately forming an optical detector on a second substrate, and operatively coupling the first substrate and the second substrate so that optical signals passed through the transmissive interferometric element are detectable by the optical detector. The transmissive interferometric element can be configured to transmit optical signals within the visible spectrum. The first transmission spectrum can correspond to a first color. The method can include forming a plurality of transmissive interferometric elements on the first substrate. The plurality of transmissive interferometric elements can include at least one transmissive interferometric element that is actuatable to allow or prevent passage of optical signals within a second transmission spectrum. The second transmission spectrum can correspond to a second color. The method can include forming a plurality of reflective interferometric elements on the first substrate. The plurality of transmissive interferometric elements can be dispersed throughout an array of the reflective interferometric elements. The plurality of transmissive interferometric elements can be positioned apart from the plurality of reflective interferometric elements. Forming the transmissive interferometric element can include forming a first surface being partially reflective and partially transmissive and a second surface being partially reflective and partially transmissive, the second surface being movable towards the first surface in response to an applied voltage. The method can include forming a plurality of the optical detectors on the second substrate. The method can include forming circuitry on the second substrate connecting the plurality of optical detectors. The method can include connecting the circuitry to a processor, the processor configured to receive and process input from the detectors. The method can include testing the optical detector before operatively coupling the first and second substrate.

In another implementation, a method of sensing an optical signal includes actuating a first set of transmissive interferometric elements in an array of transmissive interferometric elements to allow transmission of optical signals within a first spectrum through the array, receiving light at the array of transmissive interferometric elements, and detecting optical signals transmitted through the array of transmissive interferometric elements.

In yet another implementation, a computer readable storage medium includes instructions that, when executed, cause a processor to perform a method. The method includes actuating a first set of transmissive interferometric elements in an array of transmissive interferometric elements to allow transmission of optical signals within a first spectrum through the array, receiving light at the array of transmissive interferometric elements, and detecting optical signals transmitted through the array of transmissive interferometric elements.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B show examples of isometric views depicting a pixel of an interferometric modulator (IMOD) display device in two different states.

FIG. 2 shows an example of a schematic circuit diagram illustrating a driving circuit array for an optical MEMS display device.

FIG. 3 is an example of a schematic partial cross-section illustrating one implementation of the structure of the driving circuit and the associated display element of FIG. 2.

FIG. 4 is an example of a schematic exploded partial perspective view of an optical MEMS display device having an interferometric modulator array and a backplate with embedded circuitry.

FIGS. 5A and 5B show examples of a sensor with detectors formed on a backplate.

FIG. 5C shows an example of a plan view of a movable layer in a transmissive interferometric element.

FIG. 5D shows a cross-section of the movable layer of FIG. 5C, taken along line 5D-5D of FIG. 5C.

FIGS. 6A and 6B show examples of a sensor with detectors formed in a backplate.

FIG. 7A shows an example of a sensor with a one-to-one ratio of transmissive interferometric elements to detectors.

FIG. 7B shows an example of a sensor with a plurality of transmissive interferometric elements registered with each detector.

FIG. 8A shows an example of a sensor and illustrates additional details in the structure of transmissive elements in the sensor.

FIG. 8B shows an example of a sensor including a light guide over the front substrate.

FIG. 9 is an example of a graph showing the unactuated and actuated transmission spectra for various transmissive interferometric elements in a sensor.

FIG. 10 shows the spectra of various light sources.

FIG. 11 shows predicted and measured spectral curves for various skin tones.

FIG. 12 shows an example of an array with a one-to-one ratio of transmissive IMOD elements to detectors.

FIG. 13 shows an example of a display divided into sub-regions, with a single transmissive interferometric element randomly placed in each region, and with a detector disposed on the backplate behind each sub-region.

FIG. 14A shows the transmission spectra for an example of a reflective display IMOD and an example of a transmissive IMOD which are both configured to reflect green light.

FIG. 14B shows an example of a display device with optical sensors.

FIGS. 15-17 illustrate various examples of methods of forming and/or using optical sensors.

FIGS. 18A and 18B show examples of system block diagrams illustrating a display device that includes a plurality of interferometric modulators.

FIG. 19 is an example of a schematic exploded perspective view of an electronic device having an optical MEMS display.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Systems, methods, and apparatus are described herein that are related to an optical sensor for detecting proximity and/or color of a nearby object. The optical sensor can include one or more transmissive interferometric modulator (IMOD) elements which are selectively configurable to transmit light of a particular wavelength (or range of wavelengths) through the elements, such that the elements can function as tunable optical filters. The optical sensor also can include one or more optical detectors disposed so as to receive and detect light transmitted through the elements. In some implementations, an optical sensor includes a front substrate; a backplate opposing the front substrate; an array of interferometric elements formed in or on the front substrate, in which at least some of the interferometric elements are provided with a semi-transparent (transmissive) movable layer; and one or more optical detectors formed on (or partially embedded in) the backplate. Implementations also can be used to sense the presence, color, and/or intensity of ambient light near a device, such as a display device. One application involves detection of light of a particular wavelength for optical data communication with the display. Another application includes optical touch sensing. Implementations also can be used in color imaging (scanning) applications.

Particular implementations of the subject matter described in this disclosure can be implemented to realize one or more of the following potential advantages. Some implementations can leverage IMOD technology to provide enhanced sensing capability. In some implementations, single IMODs or arrays of IMOD pixels can function as tunable optical filters, allowing the wavelength content of ambient light above the IMOD(s) to be determined. Further, in some implementations, optical sensing capability can be integrated with a display module to increase the functionality and value of the display module.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

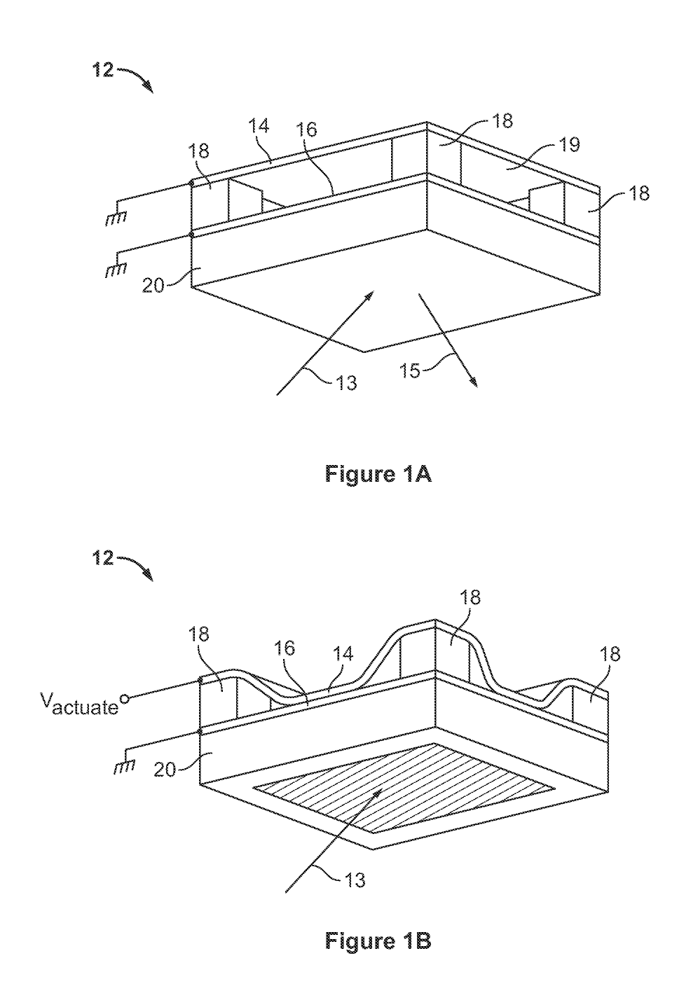

FIGS. 1A and 1B show examples of isometric views depicting a pixel of an interferometric modulator (IMOD) display device in two different states. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted pixels in FIGS. 1A and 1B depict two different states of an IMOD 12. In the IMOD 12 in FIG. 1A, a movable reflective layer 14 is illustrated in a relaxed position at a predetermined (e.g., designed) distance from an optical stack 16, which includes a partially reflective layer. Since no voltage is applied across the IMOD 12 in FIG. 1A, the movable reflective layer 14 remained in a relaxed or unactuated state. In the IMOD 12 in FIG. 1B, the movable reflective layer 14 is illustrated in an actuated position and adjacent, or nearly adjacent, to the optical stack 16. The voltage V_{actuate} applied across the IMOD 12 in FIG. 1B is sufficient to actuate the movable reflective layer 14 to an actuated position.

In FIGS. 1A and 1B, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixels 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the optical stack 16, or lower electrode, is grounded at each pixel. In some implementations, this may be accomplished by depositing a continuous optical stack 16 onto the substrate 20 and grounding at least a portion of the continuous optical stack 16 at the periphery of the deposited layers. In some implementations, a highly conductive and reflective material, such as aluminum (Al), may be used for the movable reflective layer 14. The movable reflective layer 14 may be formed as a metal layer or layers deposited on top of posts 18 and an intervening sacrificial material deposited between the posts 18. When the sacrificial material is etched away, a defined gap 19, or optical cavity, can be formed between the movable reflective layer 14 and the optical stack 16. For example, in some implementations, the spacing between posts 18 may approximately 1-1000 um, while the gap 19 may be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 in FIG. 1A, with the gap 19 between the movable reflective layer 14 and optical stack 16. However, when a potential difference, e.g., voltage, is applied to at least one of the movable reflective layer 14 and optical stack 16, the capacitor formed at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 in FIG. 1B. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

In some implementations, such as in a series or array of IMODs, the optical stacks 16 can serve as a common electrode that provides a common voltage to one side of the IMODs 12. The movable reflective layers 14 may be formed as an array of separate plates arranged in, for example, a matrix form. The separate plates can be supplied with voltage signals for driving the IMODs 12.

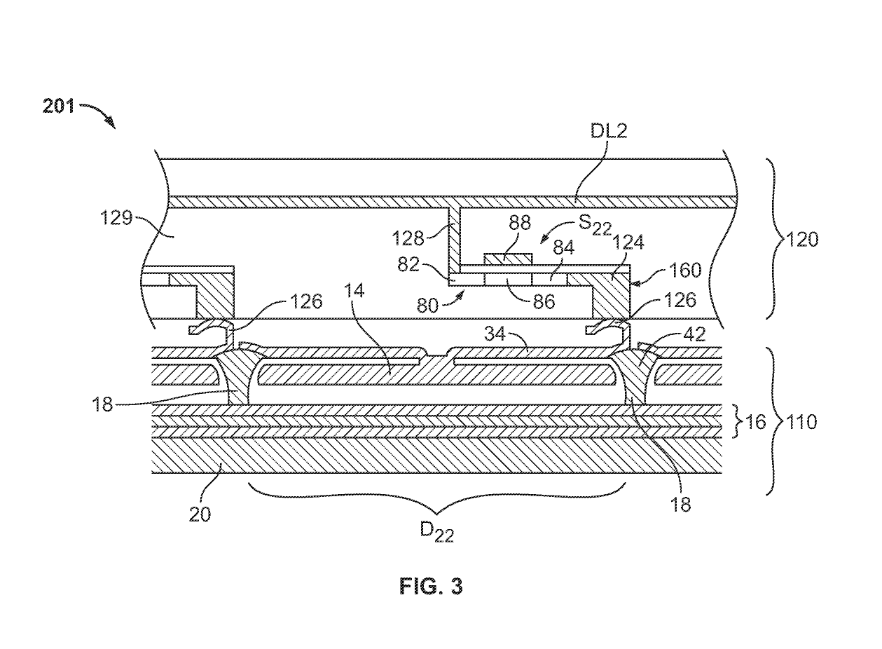

The details of the structure of interferometric modulators that operate in accordance with the principles set forth above may vary widely. For example, the movable reflective layers 14 of each IMOD 12 may be attached to supports at the corners only, e.g., on tethers. As shown in FIG. 3, a flat, relatively rigid movable reflective layer 14 may be suspended from a deformable layer 34, which may be formed from a flexible metal. This architecture allows the structural design and materials used for the electromechanical aspects and the optical aspects of the modulator to be selected, and to function, independently of each other. Thus, the structural design and materials used for the movable reflective layer 14 can be optimized with respect to the optical properties, and the structural design and materials used for the deformable layer 34 can be optimized with respect to desired mechanical properties. For example, the movable reflective layer 14 portion may be aluminum, and the deformable layer 34 portion may be nickel. The deformable layer 34 may connect, directly or indirectly, to the substrate 20 around the perimeter of the deformable layer 34. These connections may form the support posts 18.

In implementations such as those shown in FIGS. 1A and 1B, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 3) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing.

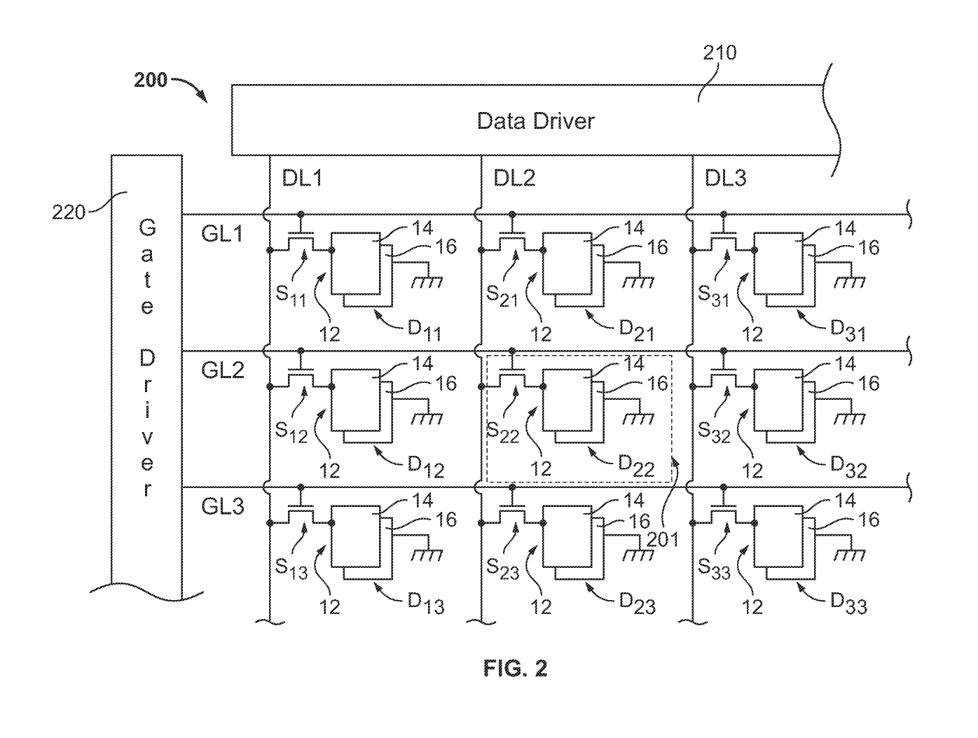

FIG. 2 shows an example of a schematic circuit diagram illustrating a driving circuit array 200 for an optical MEMS display device. The driving circuit array 200 can be used for implementing an active matrix addressing scheme for providing image data to display elements D₁₁ -Dₘₙ of a display array assembly.

The driving circuit array 200 includes a data driver 210, a gate driver 220, first to m-th data lines DL1-DLm, first to n-th gate lines GL1-GLn, and an array of switches or switching circuits S ₁₁-Sₘₙ. Each of the data lines DL1-DLm extends from the data driver 210, and is electrically connected to a respective column of switches S₁₁-S₁ₙ, S_{21 -S}₂ₙ, . . . , Sₘ₁-Sₘₙ. Each of the gate lines GL1-GLn extends from the gate driver 220, and is electrically connected to a respective row of switches S₁₁-Sₘ₁, S₁₂-Sₘ₂, . . . , S₁ₙ-Sₘₙ. The switches S₁₁-Sₘₙ are electrically coupled between one of the data lines DL1-DLm and a respective one of the display elements D₁₁-Dₘₙ and receive a switching control signal from the gate driver 220 via one of the gate lines GL1-GLn. The switches S₁₁-Sₘₙ are illustrated as single FET transistors, but may take a variety of forms such as two transistor transmission gates (for current flow in both directions) or even mechanical MEMS switches.

The data driver 210 can receive image data from outside the display, and can provide the image data on a row by row basis in a form of voltage signals to the switches S₁₁-Sₘₙ via the data lines DL1-DLm. The gate driver 220 can select a particular row of display elements D₁₁-Dₘ₁, D₁₂-Dₘ₂, . . . , D₁ₙ-Dₘₙ by turning on the switches S₁₁-Sₘ₁, S₁₂-Sₘ₂, . . . , S₁ₙ-Sₘₙ associated with the selected row of display elements D₁₁-Dₘ₁, D₁₂-Dₘ₂, . . . , D₁ₙ-Dₘₙ. When the switches S₁₁-Sₘ₁, S₁₂-Sₘ₂, . . . , S₁ₙ-Sₘₙ in the selected row are turned on, the image data from the data driver 210 is passed to the selected row of display elements D₁₁-Dₘ₁, D₁₂-Dₘ₂, . . . , D₁ₙ-Dₘₙ.

During operation, the gate driver 220 can provide a voltage signal via one of the gate lines GL1-GLn to the gates of the switches S ₁₁-Sₘₙ in a selected row, thereby turning on the switches S₁₁-Sₘₙ. After the data driver 210 provides image data to all of the data lines DL1-DLm, the switches S₁₁-Sₘₙ of the selected row can be turned on to provide the image data to the selected row of display elements D₁₁-Dₘ₁, D₁₂-Dₘ₂, . . . , D₁ₙ-Dₘₙ, thereby displaying a portion of an image. For example, data lines DL that are associated with pixels that are to be actuated in the row can be set to, e.g., 10-volts (could be positive or negative), and data lines DL that are associated with pixels that are to be released in the row can be set to, e.g., 0-volts. Then, the gate line GL for the given row is asserted, turning the switches in that row on, and applying the selected data line voltage to each pixel of that row. This charges and actuates the pixels that have 10-volts applied, and discharges and releases the pixels that have 0-volts applied. Then, the switches S ₁₁-Sₘₙ can be turned off. The display elements D₁₁-Dₘ₁, D₁₂-Dₘ₂, . . . , D₁ₙ-Dₘₙ can hold the image data because the charge on the actuated pixels will be retained when the switches are off, except for some leakage through insulators and the off state switch. Generally, this leakage is low enough to retain the image data on the pixels until another set of data is written to the row. These steps can be repeated to each succeeding row until all of the rows have been selected and image data has been provided thereto. In the implementation of FIG. 2, the optical stack 16 is grounded at each pixel. In some implementations, this may be accomplished by depositing a continuous optical stack 16 onto the substrate and grounding the entire sheet at the periphery of the deposited layers.

FIG. 3 is an example of a schematic partial cross-section illustrating one implementation of the structure of the driving circuit and the associated display element of FIG. 2. A portion 201 of the driving circuit array 200 includes the switch S₂₂ at the second column and the second row, and the associated display element D₂₂. In the illustrated implementation, the switch S₂₂ includes a transistor 80. Other switches in the driving circuit array 200 can have the same configuration as the switch S₂₂, or can be configured differently, for example by changing the structure, the polarity, or the material.

FIG. 3 also includes a portion of a display array assembly 110, and a portion of a backplate 120. The portion of the display array assembly 110 includes the display element D₂₂ of FIG. 2. The display element D₂₂ includes a portion of a front substrate 20, a portion of an optical stack 16 formed on the front substrate 20, supports 18 formed on the optical stack 16, a movable reflective layer 14 (or a movable electrode connected to a deformable layer 34) supported by the supports 18, and an interconnect 126 electrically connecting the movable reflective layer 14 to one or more components of the backplate 120.

The portion of the backplate 120 includes the second data line DL2 and the switch S₂₂ of FIG. 2, which are embedded in the backplate 120. The portion of the backplate 120 also includes a first interconnect 128 and a second interconnect 124 at least partially embedded therein. The second data line DL2 extends substantially horizontally through the backplate 120. The switch S₂₂ includes a transistor 80 that has a source 82, a drain 84, a channel 86 between the source 82 and the drain 84, and a gate 88 overlying the channel 86. The transistor 80 can be, e.g., a thin film transistor (TFT) or metal-oxide-semiconductor field effect transistor (MOSFET). The gate of the transistor 80 can be formed by gate line GL2 extending through the backplate 120 perpendicular to data line DL2. The first interconnect 128 electrically couples the second data line DL2 to the source 82 of the transistor 80.

The transistor 80 is coupled to the display element D₂₂ through one or more vias 160 through the backplate 120. The vias 160 are filled with conductive material to provide electrical connection between components (for example, the display element D₂₂) of the display array assembly 110 and components of the backplate 120. In the illustrated implementation, the second interconnect 124 is formed through the via 160, and electrically couples the drain 84 of the transistor 80 to the display array assembly 110. The backplate 120 also can include one or more insulating layers 129 that electrically insulate the foregoing components of the driving circuit array 200.

The optical stack 16 of FIG. 3 is illustrated as three layers, a top dielectric layer described above, a middle partially reflective layer (such as chromium) also described above, and a lower layer including a transparent conductor (such as indium-tin-oxide (ITO)). The common electrode is formed by the ITO layer and can be coupled to ground at the periphery of the display. In some implementations, the optical stack 16 can include more or fewer layers. For example, in some implementations, the optical stack 16 can include one or more insulating or dielectric layers covering one or more conductive layers or a combined conductive/absorptive layer.

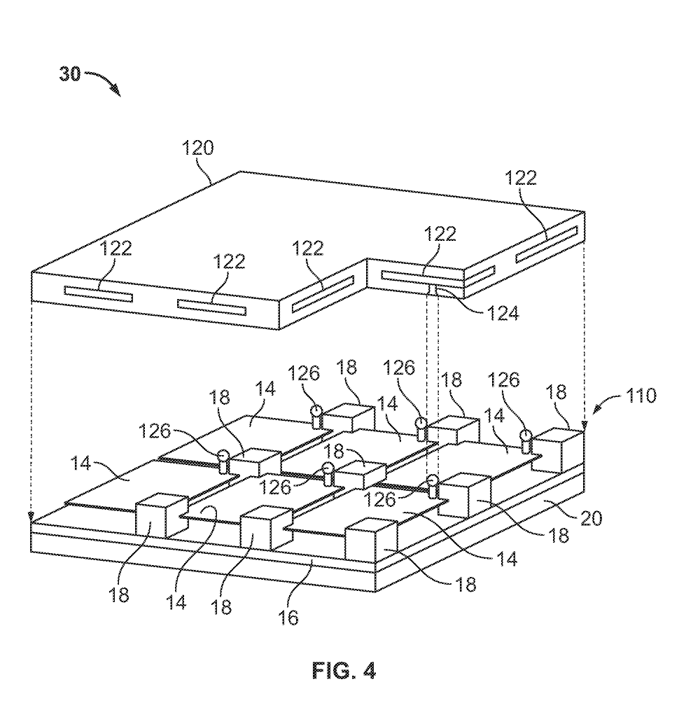

FIG. 4 is an example of a schematic exploded partial perspective view of an optical MEMS display device 30 having an interferometric modulator array and a backplate with embedded circuitry. The display device 30 includes a display array assembly 110 and a backplate 120. In some implementations, the display array assembly 110 and the backplate 120 can be separately pre-formed before being attached together. In some other implementations, the display device 30 can be fabricated in any suitable manner, such as, by forming components of the backplate 120 over the display array assembly 110 by deposition.

The display array assembly 110 can include a front substrate 20, an optical stack 16, supports 18, a movable reflective layer 14, and interconnects 126. The backplate 120 can include backplate components 122 at least partially embedded therein, and one or more backplate interconnects 124.

The optical stack 16 of the display array assembly 110 can be a substantially continuous layer covering at least the array region of the front substrate 20. The optical stack 16 can include a substantially transparent conductive layer that is electrically connected to ground. The reflective layers 14 can be separate from one another and can have, e.g., a square or rectangular shape. The movable reflective layers 14 can be arranged in a matrix form such that each of the movable reflective layers 14 can form part of a display element. In the implementation illustrated in FIG. 4, the movable reflective layers 14 are supported by the supports 18 at four corners.

Each of the interconnects 126 of the display array assembly 110 serves to electrically couple a respective one of the movable reflective layers 14 to one or more backplate components 122 (e.g., transistors S and/or other circuit elements). In the illustrated implementation, the interconnects 126 of the display array assembly 110 extend from the movable reflective layers 14, and are positioned to contact the backplate interconnects 124. In another implementation, the interconnects 126 of the display array assembly 110 can be at least partially embedded in the supports 18 while being exposed through top surfaces of the supports 18. In such an implementation, the backplate interconnects 124 can be positioned to contact exposed portions of the interconnects 126 of the display array assembly 110. In yet another implementation, the backplate interconnects 124 can extend from the backplate 120 toward the movable reflective layers 14 so as to contact and thereby electrically connect to the movable reflective layers 14.

The interferometric modulators described above have been described as bi-stable elements having a relaxed state and an actuated state. The above and following description, however, also may be used with analog interferometric modulators having a range of states. For example, an analog interferometric modulator can have a red state, a green state, a blue state, a black state and a white state, in addition to other color states Accordingly, a single interferometric modulator can be configured to have various states with different light reflectance properties over a wide range of the optical spectrum.

Interferometric modulators (IMODs) are bi-stable devices which can switch states to alternatively absorb or reflect certain frequencies of light. An IMOD can include a reflective movable layer and a partially-reflective fixed layer spaced apart by a gap, and can switch states when the movable layer is collapsed against the fixed layer. In a two-tone IMOD element, a plurality of IMODs are arranged in rows and/or columns, with all of the IMODs configured to reflect predominantly at a particular wavelength (at least when they are in a given state). In a multicolor IMOD element, a plurality of IMODs are arranged in rows and/or columns, with the IMODs of a particular row or column configured with a different gap height so as to reflect different frequencies of light.

In some implementations, one or more two-tone or multicolor interferometric elements having a semi-transparent (transmissive) movable layer form part of a sensor. In such an implementation, individual interferometric modulators (or pixels) can be configured to transmit different frequencies or wavelengths of light through the element. One or more detectors can be positioned behind the elements so as to receive and detect light which is transmitted through the elements. In some implementations, the transmissive interferometric elements can be fabricated on a front substrate and joined to a low temperature polysilicon (LTPS) backplate, in or on which one or more optical detectors are formed. Light incident upon the elements can be analyzed by selective actuation of the pixels in the sensor to transmit particular wavelengths of light to the detector(s). Transmissive interferometric elements can thus be configured to function as tunable optical filters, allowing the wavelength content of ambient light above the sensor to be determined. A transmissive interferometric element (or array of such elements), in combination with an optical detector formed on a backplate, can thus function as a wavelength-sensitive detector or spectrometer. Transmissive interferometric elements and detectors also can be incorporated into an array of reflective display elements, so that the display can include optical and/or touch sensing functionality.

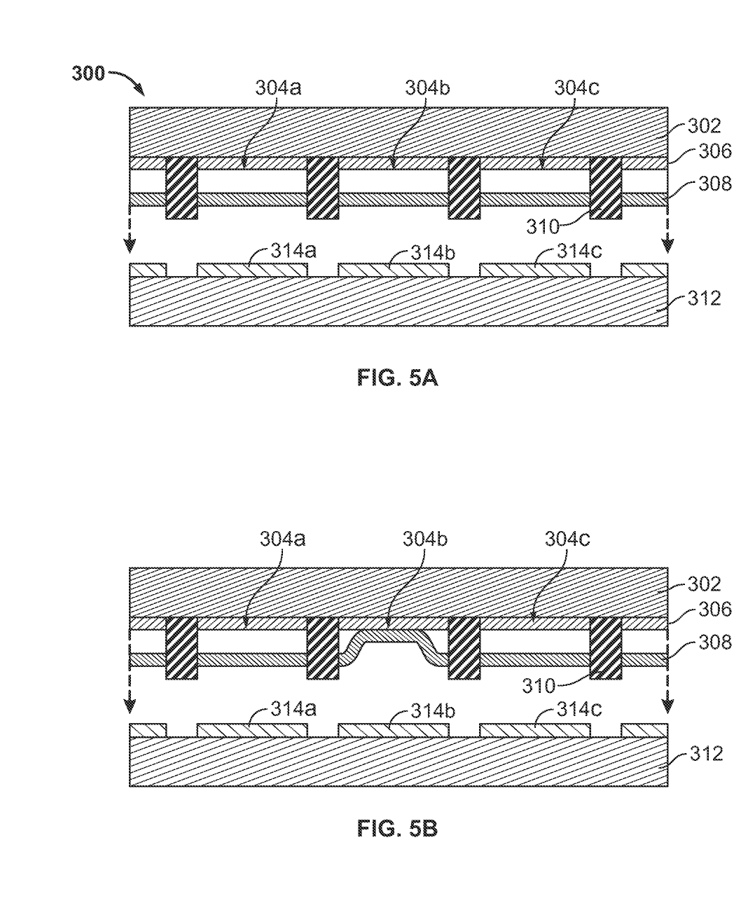

FIGS. 5A and 5B show an example of an optical sensor 300 according to an implementation. Note that these and the other figures may not be drawn to scale, and certain dimensions, relative dimensions, and spacings may be exaggerated for illustrative purposes. The sensor 300 can include a transparent front substrate 302 with a plurality of interferometric elements formed on the substrate 302, including elements 304a, 304b and 304c. Each of the elements 304a, 304b, and 304c includes an optical stack 306 having a partially reflective and a partially transmissive layer, and a movable layer 308 which is also configured to be partially reflective and partially transmissive. In the unactuated state illustrated in FIG. 5A, the movable layer 308 is spaced apart from the optical stack 306 by one or more supports 310. A backplate 312 is operatively coupled to the front substrate 302. A plurality of detectors 314a, 314b, and 314c are formed on the backplate 312. In the unactuated state, the elements 304 can be configured to transmit light of a particular wavelength (or range of wavelengths) through the elements 304 and toward the backplate 312. In other words, the transmissive interferometric elements 304 can act as transmission filters for selected wavelengths (or bands) of light. Each detector 314 is configured to receive and detect light transmitted through the interferometric elements 304. In some implementations, the detectors can be TFTs formed in a LTPS backplate. In the illustrated implementation, each detector 314 is registered with a single interferometric element 304. FIG. 5B shows the optical sensor 300 of FIG. 5A with the middle element 304b in an actuated state. In the actuated state, the middle element 304b can be configured to absorb, instead of transmit, light incident on the sensor 300.

The movable layer 308 can be made partially transmissive in a variety of ways. In one implementation, the movable layer 308 can be formed using a material which transmits light in the visible wavelength range (from about 400 nm-700 nm) such as, for example, silicon oxynitride (SiONₓ). In such an implementation, the SiONₓ layer can have a thickness of, for example, between about 50 nm-200 nm. FIG. 5C shows an example of a plan view of a movable layer 308 in a transmissive interferometric element. FIG. 5D shows a cross-section of the movable layer of FIG. 5C, taken along line 5D-5D of FIG. 5C. In one implementation, as shown in FIGS. 5C and 5D, the movable layer 308 can include a transparent layer 320 and one or more coating layers 322. The transparent layer 320 can include a dielectric material. The coating layer(s) 322 can be a metal, such as an opaque metal, and can include one or more apertures 324 configured to allow light to reach and pass through the transparent layer 320. In some implementations, each of the coating layer(s) 322 can have a thickness of, for example, between about 30 nm-50 nm. The implementation illustrated in FIGS. 5C and 5D includes coating layers 322 on both sides of the dielectric layer 320, however, in some implementations, a single layer 322 can be disposed on only one side of the dielectric layer 320.

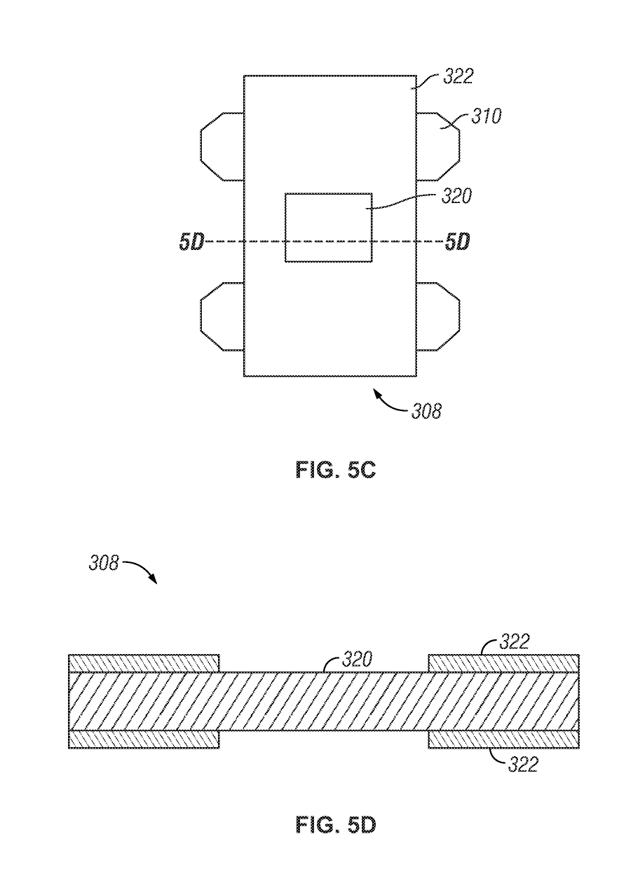

FIGS. 6A and 6B show an example of an optical sensor 340 according to another implementation. The sensor 340 includes a transparent front substrate 342 with a plurality of interferometric elements formed on the substrate 342, including elements 344a, 344b and 344c. Each of the elements 344a, 344b, and 344c can respectively include a partially transmissive layer 346a, 346b, and 346c and a partially transmissive layer 348a, 348b, and 348c which is movable with respect to its corresponding partially transmissive layer 346a, 346b, and 346c. In the unactuated state illustrated in FIG. 6A, each layer 348a, 348b, and 348c is spaced apart from its corresponding layer 346a, 346b, and 346c by one or more supports 350. Each of the elements 344a, 344b, and 344c can be configured to have a different gap height between the layers 346a, 346b, and 346c and the layers 348a, 348b, and 348c. In such an implementation, each of the elements 344a, 344b, and 344c can be configured to transmit light of a different wavelength (or range of wavelengths) in their unactuated states. Each movable layer 348a, 348b, and 348c also can be configured with the same or different materials, thickness, and/or stiffness, in order to obtain a desired transmission spectrum and a desired actuation behavior for each transmissive element 344a, 344b, and 344c. A backplate 352 is operatively coupled to the front substrate 342. The backplate 352 includes a plurality of detectors 354a, 354b, and 354c formed therein. Each detector 354 can be arranged to receive and detect light transmitted through the interferometric elements 344. In some implementations, adjacent detectors 354 can be electrically coupled to one another, for example in rows and/or columns, by connections extending through the material of the backplate 352, over the backplate 352, or behind the backplate 352. In some implementations, the detectors 354 can be coupled to a processor configured to receive and process input from the detectors 354.

FIG. 6B shows the optical sensor 340 of FIG. 6A with two elements 344a and 344b in an actuated state. In the state shown in FIG. 6A, wavelengths of incident light corresponding to the transmission spectrum of element 344c will be transmitted toward the backplate 352 and detected by the detector 354c, while other wavelengths (including those corresponding to the transmission spectra of elements 344a and 344b) will be absorbed and/or reflected back away from the sensor 340. Thus, light incident on the sensor 340 from directed or ambient light can be analyzed by independently, and/or selectively, actuating the individual elements 344a, 344b, and 344c to transmit different wavelengths of light to (or to block different wavelengths of light from reaching) the detectors 354a, 354b, and 354c. Any number or combination of elements can be actuated, (i.e., actuatable) to produce a desired spectral response.

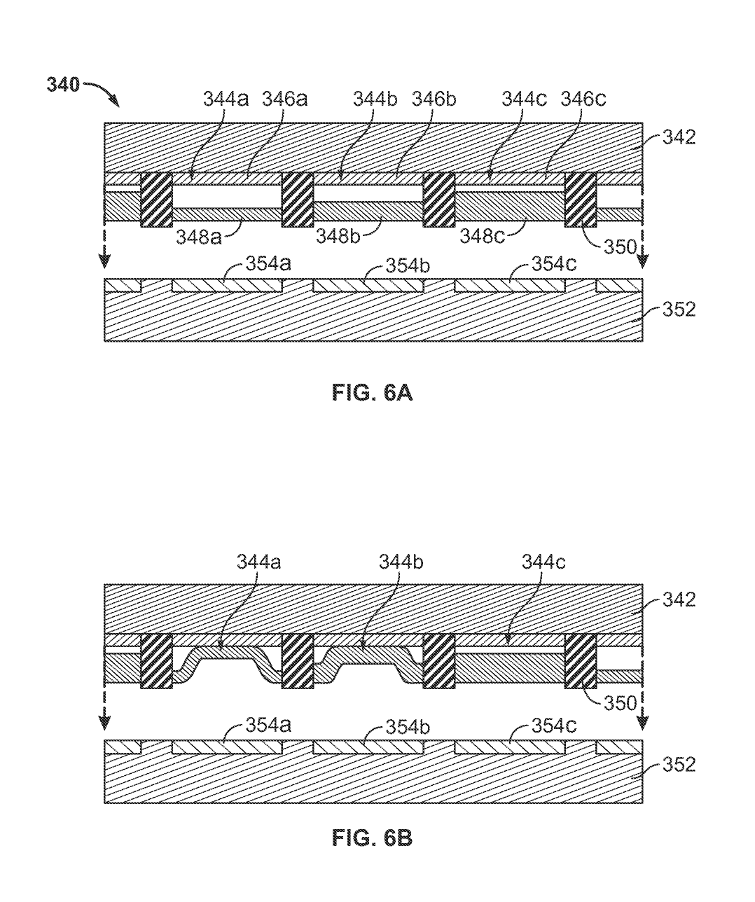

FIG. 7A illustrates another example of an implementation of a sensor 380 that includes a plurality of transmissive interferometric elements 382a, 382b, and 382c disposed on a transparent front substrate 384, and a plurality of detectors 386a, 386b, and 386c formed on a backplate 388. In the implementation illustrated in FIG. 7A, the respective movable layers 390a, 390b, and 390c of the interferometric elements 382a, 382b, and 382c are spaced apart from the fixed layers 392a, 392b, and 392c by different distances. The movable layers 390a, 390b, and 390c can be of substantially the same thickness, or can have different or varying thicknesses among the elements 382. In the implementation shown in FIG. 7A, each interferometric element 382a, 382b, and 382c is respectively registered with an individual detector 386a, 386b, and 386c, such that each detector is configured to receive and detect light transmitted through a single interferometric element. The active surface area of the detectors 386a, 386b, and 386c can be roughly the same size as the optically active area of the corresponding interferometric elements 382a, 382b, and 382c, or can be larger or smaller than the optically active surface area of the interferometric elements 382a, 382b, and 382c. In some implementations, as shown in FIG. 7B, each detector 392 can be formed in or on a backplate 394 and configured to receive and detect light from a plurality of transmissive interferometric elements 396a, 396b, and 396c. In such an implementation, the plurality of transmissive interferometric elements 396 can be selectively actuated to collectively define the overall transmission spectra to each detector 392. For example, in order to sense a violet color, a combination of red and blue transmissive interferometric elements can be left open (unactuated), while all other elements are closed (actuated). Also, in some implementations, the characteristics of the detectors 392 themselves can contribute to determining the wavelength of light received at the detectors 392. For example, in some implementations, the detectors 392 can be configured to produce a different level of current depending on the wavelength of light that reaches the detectors 392.

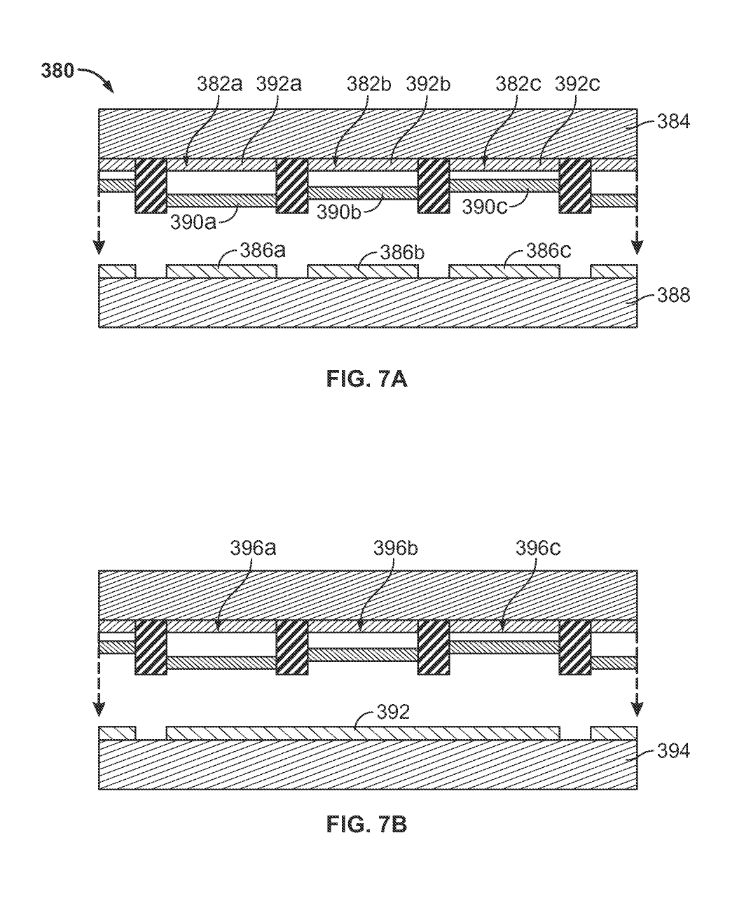

FIG. 8A shows another example of an implementation of a sensor 400, and illustrates one possible configuration of transmissive interferometric elements in greater detail. FIG. 8A shows three transmissive interferometric elements 402a, 402b, and 402c, each configured to transmit light of a different wavelength, at least when in an unactuated state. The elements 402a, 402b, and 402c are disposed on a front substrate 430, and respectively registered with detectors 432a, 432b, and 432c formed on a backplate 434. Each element 402a, 402b, and 402c has an optical stack 404a, 404b, and 404c and a movable layer 406a, 406b, and 406c spaced apart from the corresponding optical stack by a different gap height. Each optical stack 404a, 404b, and 404c includes a dielectric layer 408, a partially reflective and partially transmissive layer and electrode layer 410, and dielectric layers 412 and 414. Each movable layer 406a, 406b, and 406c includes one or more layers of a dielectric material, a conductive material, and/or any other suitable material. The materials and thicknesses for each movable layer 406a, 406b, and 406c can be selected to transmit light of a particular wavelength (or range of wavelengths). In the implementation illustrated in FIG. 8A, each movable layer 406a, 406b, and 406c includes a flexible layer 420 and an electrode layer 422. In some implementations, the flexible layer 420 can be formed directly over and/or in continuous contact with the electrode layer 422. Depending on the particular application, the flexible layer 420 can include a dielectric material, a conductive material, or any other suitable material. In addition, in some implementations, the movable layers 406a, 406b, and 406c can have different thicknesses, and/or multiple layers of the same or different thicknesses. For example, the movable layer 406a of element 402a can include a single electrode layer 422 and a single flexible layer 420. The movable layer 406c of element 402c can have an additional supporting layer 424 in order to increase the rigidity, or stiffness, of the movable layer 406c relative to movable layer 406a. The movable layer 406b of element 402b can have yet another supporting layer 426 to increase the stiffness of the movable layer 406b relative to the movable layer 406c. The various layers 420, 424, and 426 can include the same or different material, and can have the same or different thicknesses as appropriate for the particular application. In such a configuration, the elements 402 in the device can be configured to change state when exposed to similar actuation voltages.

Also illustrated in FIG. 8A are optical mask structures 416 overlying the supports 418. The optical mask structures 416, also referred to as “black mask” structures, can be configured to absorb ambient or stray light and to improve the optical response of a display device by increasing the contrast ratio. In some applications, the optical mask structures 416 can reflect light of a predetermined wavelength to appear as a color other than black. The optical mask structures 416 also can be conductive, and thus can be configured to function as an electrical bussing layer. The conductive bus structures can be configured with a lower electrical resistance than the electrodes of the movable layer 406 and/or the optical stack 404, to improve the response time of the elements in an array. A conductive bus structure also can be provided separately from the optical mask structure 416. A conductive mask or other conductive bus structure can be electrically coupled to one or more of the elements on the device to provide one or more electrical paths for voltages applied to one or more of the device elements. For example, depending on the configuration desired, one or more of the electrode layers 410 can be connected to the conductive bus structure to reduce the resistance of the connected electrode layer. In some implementations, the conductive bus structures can be connected to the electrodes 410 or 422 through one or more vias (not shown in FIG. 8A), which can be disposed overlying the supports 418 or in any other suitable location.

FIG. 8B shows an example of a sensor 440 according to another implementation. The sensor 440 is configured similar to the sensor 400 illustrated in FIG. 8A, but also includes a light guide 442 overlying the front substrate 444. The light guide 442 is configured to receive and direct light from a light source 446.

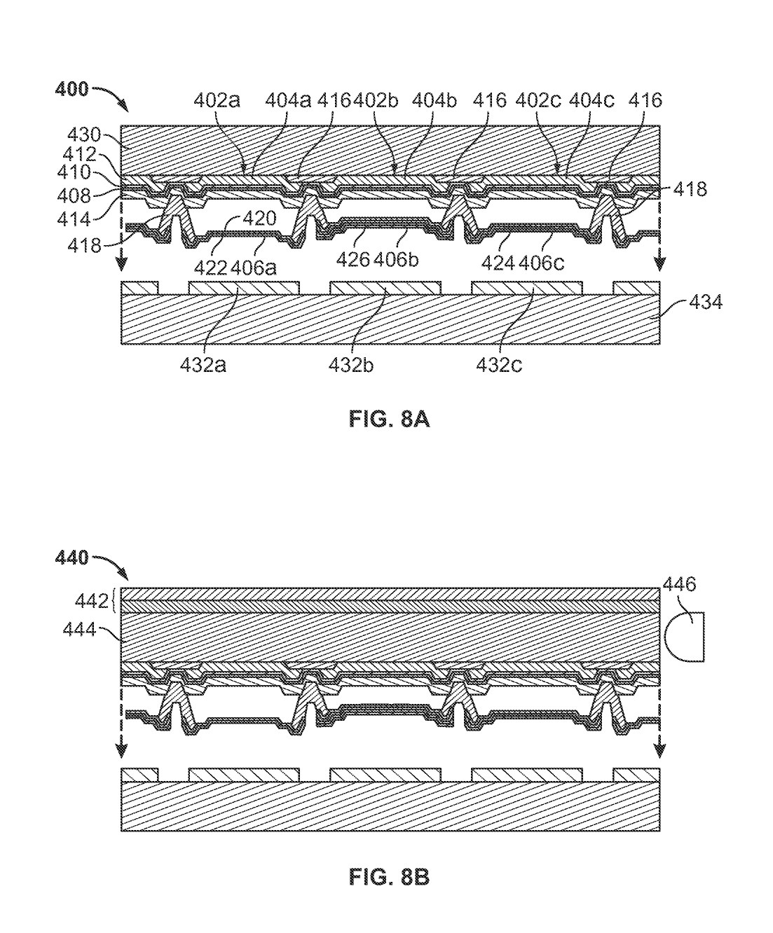

FIG. 9 shows an example of a graph of unactuated versus actuated (i.e., downstate) transmission spectra for various transmissive interferometric elements, such as, for example, the high gap, mid gap, and low gap interferometric elements 382a, 382b, and 382c illustrated in FIG. 7A. As can be seen in the graph, the high gap element is configured to transmit light in the blue band, the mid gap element is configured to transmit light in the red band, and the low gap element is configured to transmit light in the green band, at least when the elements are in their unactuated state. In some other implementations, the high, medium, and low gap elements can be configured to transmit light in the red, green, and blue bands, respectively, at least when the elements are in their unactuated state. The heavy dashed line shows the downstate transmissive spectra for the elements when they are all in their actuated (or down) state.

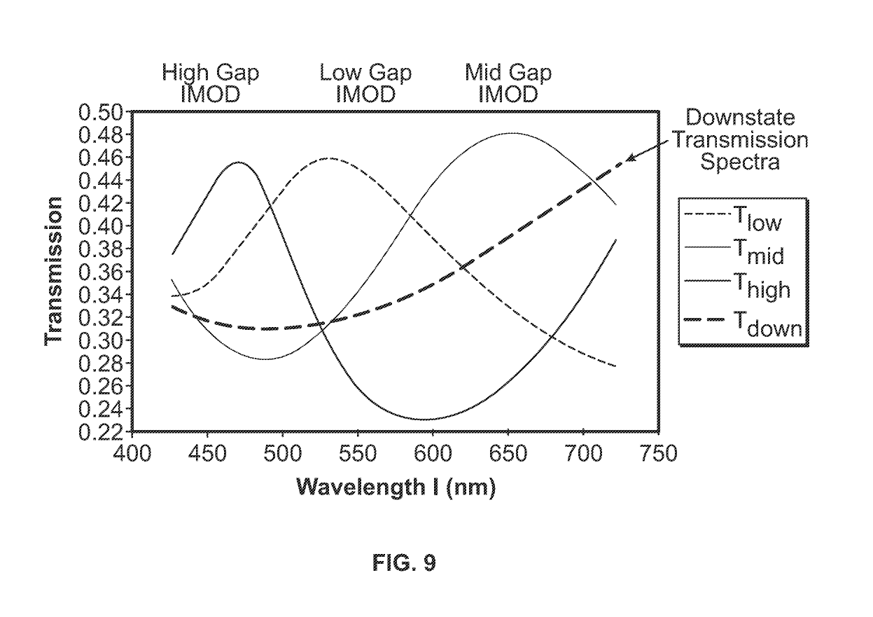

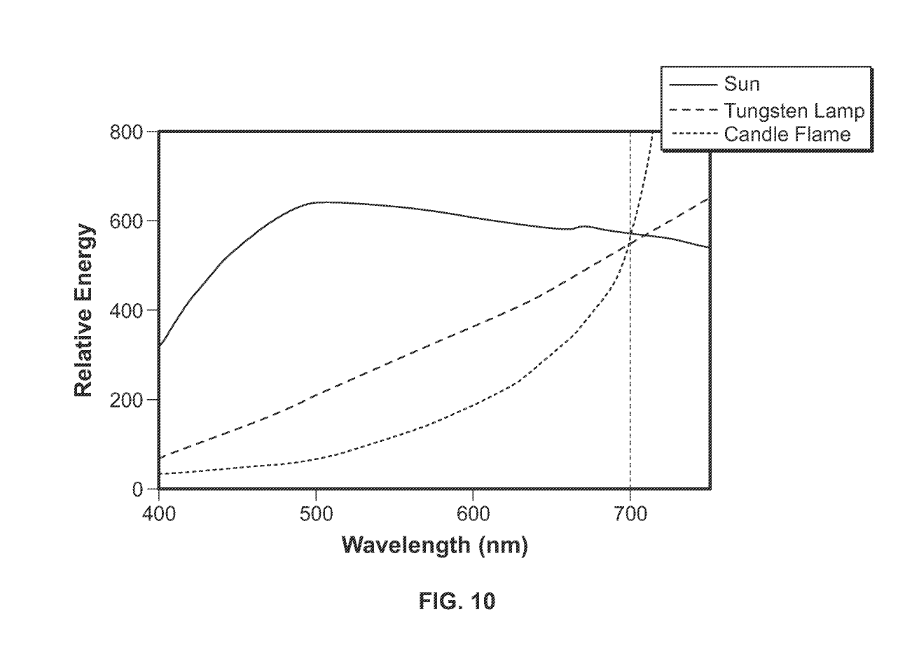

FIG. 10 shows the modeled spectra of various light sources (the sun, a tungsten lamp and a candle flame). FIG. 11 shows predicted and measured spectral curves for various skin tones. In some implementations, the proximity of an object, such as a fingertip, can be detected by comparing the spectrum of light reflected by the skin toward a sensor, and comparing the reflected light to the appropriate reference spectrum. In some implementations, a sensor can include one or more transmissive interferometric elements that are configured to allow only certain wavelengths—for example, wavelengths associated with specific objects—to pass through to the detector(s). By such a configuration, the sensor can selectively sense the presence of, for example, a human finger, as opposed to another object, like a pen or a shirt sleeve brushing up against the sensor, or can selectively sense the presence of harmful ultraviolet rays as opposed to visible light.

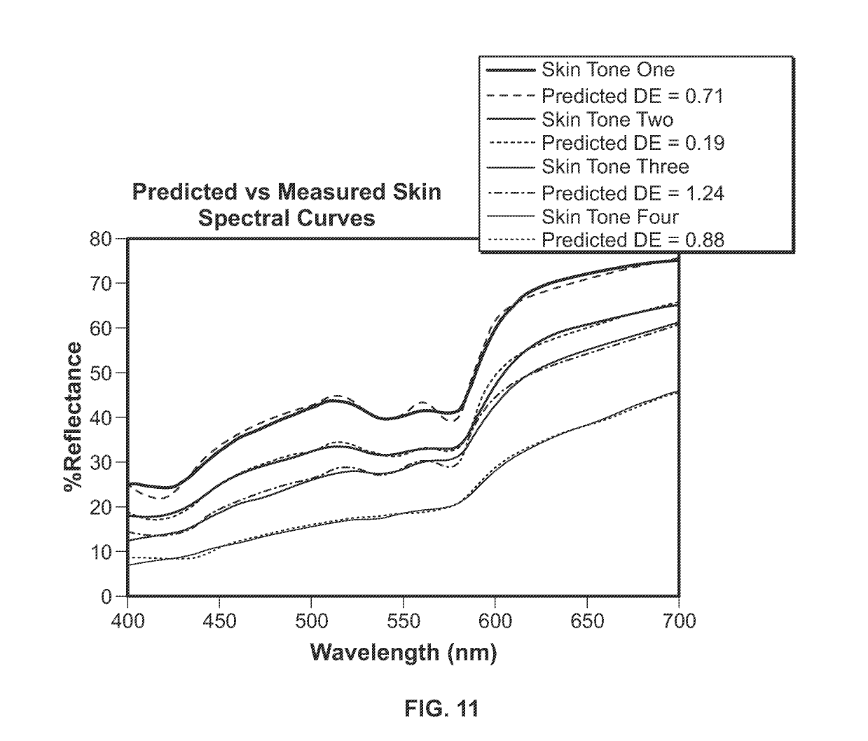

In some implementations, as illustrated in FIG. 12, a sensor 500 can include an array of transmissive interferometric elements 502 disposed on a transparent front substrate (not shown), and an array of detectors 504 disposed on a backplate 506, with a one-to-one ratio of transmissive interferometric elements 502 to detectors 504. By such a configuration, the sensor 500 can be used for one-to-one imaging of illuminated objects (including but not limited to barcodes, pictures and fingerprints) near the surface of the sensor 500, using ambient light or a display front light (such as light source 446 in FIG. 8B) for illumination. Depending on the particular application, the transmissive interferometric elements 502 can be configured to transmit the same color of light, or different colors of light in any suitable combination and/or pattern. In some implementations, the sensor 500 can be disposed near or even over a display array, and configured to communicate with the display device.

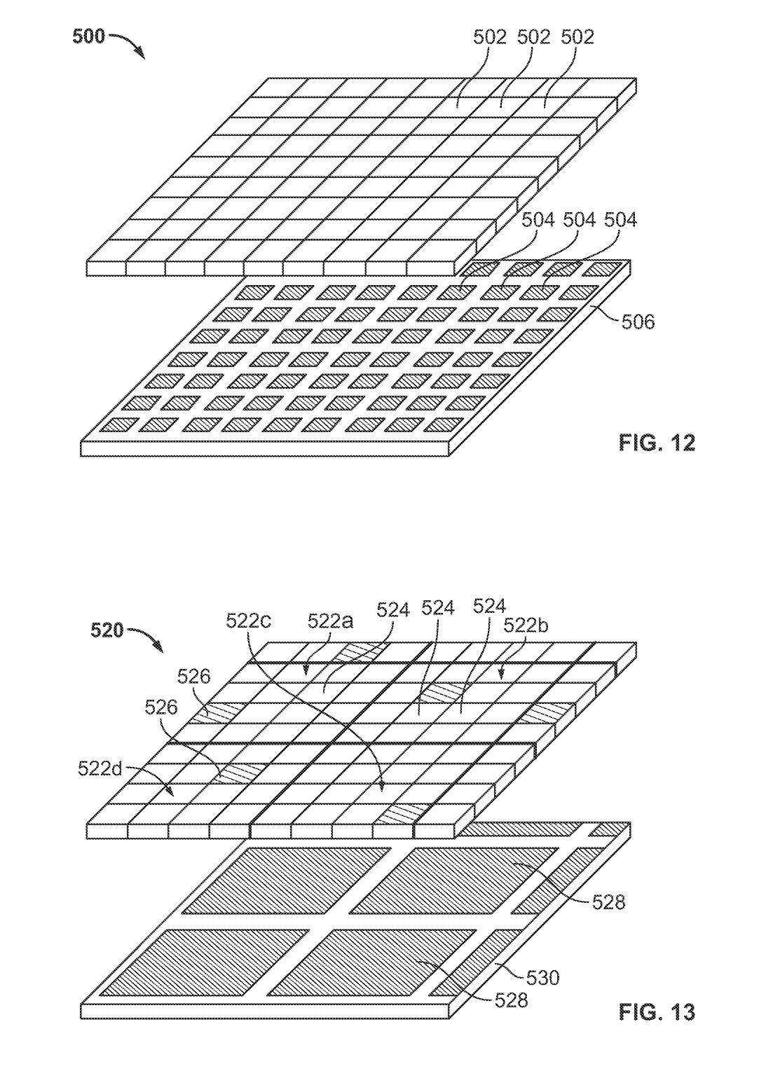

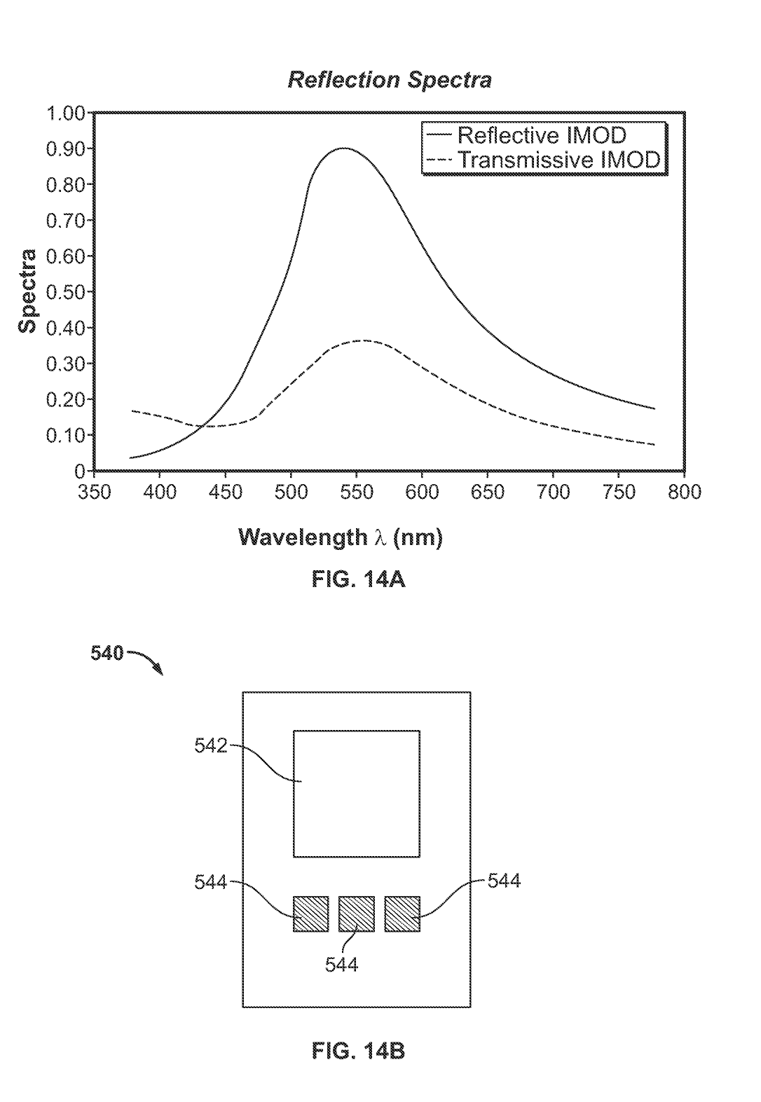

In some implementations, as illustrated in FIG. 13, a display device can include an array 520 of interferometric elements which is divided into sub-regions 522a, 522b, 522c, and 522d. Each sub-region can include one or more reflective interferometric elements 524 configured to produce a display, as well as one or more transmissive interferometric elements 526 either regularly or randomly placed in each sub-region 522a, 522b, 522c, and 522d and configured to transmit light of pre-selected wavelengths through the array 520 toward a backplate 530. One or more detectors 528 can be disposed on the backplate 530 behind each sub-region 522a, 522b, 522c, and 522d. In such a configuration, the array 520 can be used as both an optical sensor and a display. In some implementations, the array 520 can be configured as a touch-sensitive (or touchscreen) display and detect touch continuously over the display area. Although the display elements 524 and the transmissive elements 522 are illustrated having the same size, a person having ordinary skill in the art will readily recognize that the elements 522 and 524 can be of different sizes. In some implementations, the transmissive elements 522 can be dispersed through an array of display elements 524 with enough resolution to detect touch, but with limited frequency and with random placement so as not to interfere with the appearance or optical performance of the display itself. For example, in one implementation, one transmissive interferometric element of about 30-250 μm² can be included per 2 mm×2 mm to 5 mm×5 mm of display area. In some implementations, the transmissive interferometric elements 526 can be configured to reflect the same color as the reflective interferometric elements 524, but may do so with less brightness and saturation. As an example, FIG. 14A shows the transmission spectra for a reflective display IMOD and a transmissive IMOD which are both configured to reflect green light. In some implementations, a pixel can be provided with a sensor and no IMOD, e.g., the area where an IMOD would be can be empty.

FIG. 14B shows an example of a display device 540 with a touchscreen display portion 542, which can include an array of reflective and transmissive interferometric elements and detectors similar to the ones illustrated in FIG. 13, as well as one or more sensor portions 544, which can include an array of transmissive interferometric elements and detectors similar to the ones illustrated in FIG. 12. The sensor portions 544 can thus be configured to function as a “button,” e.g., for toggling on and off, selecting or deselecting functionality of an associated electronic device.

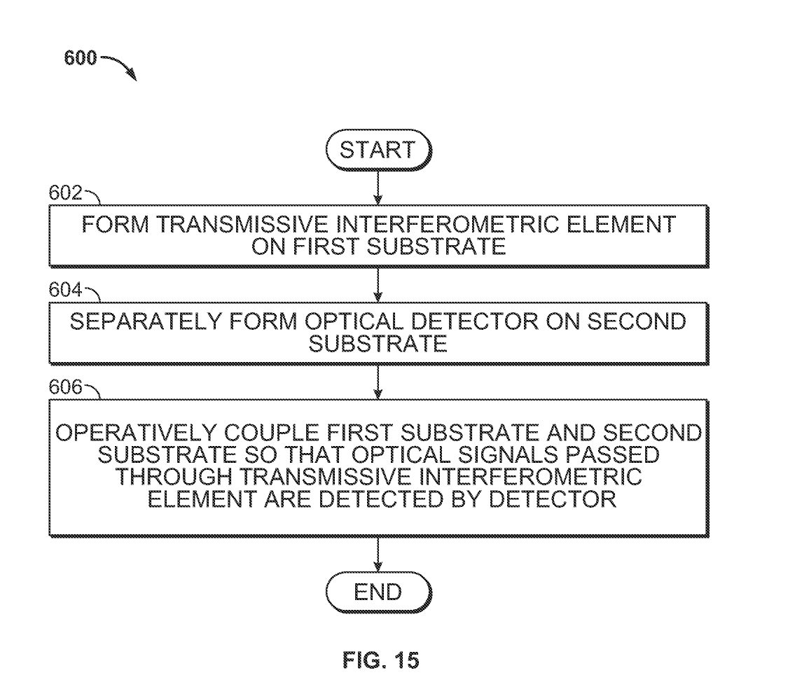

With reference now to FIG. 15, certain stages in one implementation of a manufacturing process 600 for forming an optical sensor are illustrated. The process 600 begins at block 602 with the formation of a transmissive interferometric element over a first substrate. The first substrate can be a transparent substrate such as glass or plastic and may have been subjected to prior preparation block(s), e.g., cleaning, to facilitate efficient formation of the optical stack. As discussed above, the transmissive interferometric element can include an optical stack and a movable layer, each of which can include a partially transparent and partially reflective layer. The transmissive interferometric element can be fabricated, for example, by deposition, etching, and/or removal of one or more layers onto the transparent substrate. The transmissive interferometric element can be specially configured to have a different transmission spectrum in its actuated and unactuated states. For example, a transmissive interferometric element can be configured to transmit light of a particular wavelength (or range of wavelengths) through the element when it is in an unactuated state, and absorb or reflect light of that wavelength and other wavelengths when it is in an actuated state. In other implementations, the light-transmissive behavior of a transmissive interferometric element can be reversed, so that the element transmits light of a particular wavelength through the element when it is in an actuated state, and absorbs or reflects light of that and other wavelengths when it is in an unactuated state. In some implementations, one or more reflective display elements also can be formed over the first substrate, adjacent to or spaced apart from the transmissive interferometric element.

The process 600 illustrated in FIG. 15 continues at block 604 with the separate formation of an optical detector on a second substrate. In some implementations, the second substrate can be a low-temperature polysilicon backplate. The formation of the optical detector can include formation of a thin-film transistor or photodiode in a low-temperature polysilicon backplate. In some implementations, the second substrate can be a backplate on which the optical detector is formed using organic thin-film transistors, photodiodes, or photoconductors.

The process 600 continues at block 606 with the operative coupling of the first substrate and the second substrate, so that optical signals passed through the transmissive interferometric element are detected by the detector. The first and second substrates can be coupled in a packaging process which encloses the transmissive interferometric elements and detectors between the first and second substrates and protects the elements and detectors from the external environment. In some implementations, the coupling or packaging block can involve registering the detector with one or more of the transmissive interferometric elements.

By forming the backplate and detector(s) in a separate block 604 from the formation of the transmissive interferometric elements at block 602, and subsequently coupling the two structures together at block 606, a greater manufacturing flexibility is achieved, as neither process is limited by the other. For example, higher temperatures may be used in the separate formation of the optical detector elements which might otherwise damage portions of the interferometric elements if both structures were formed in a monolithic process. In some implementations, the transmissive interferometric elements are not directly coupled to the detector(s), allowing for separate testing and optimization of the interferometric elements and detectors, thereby resulting in a higher overall yield.

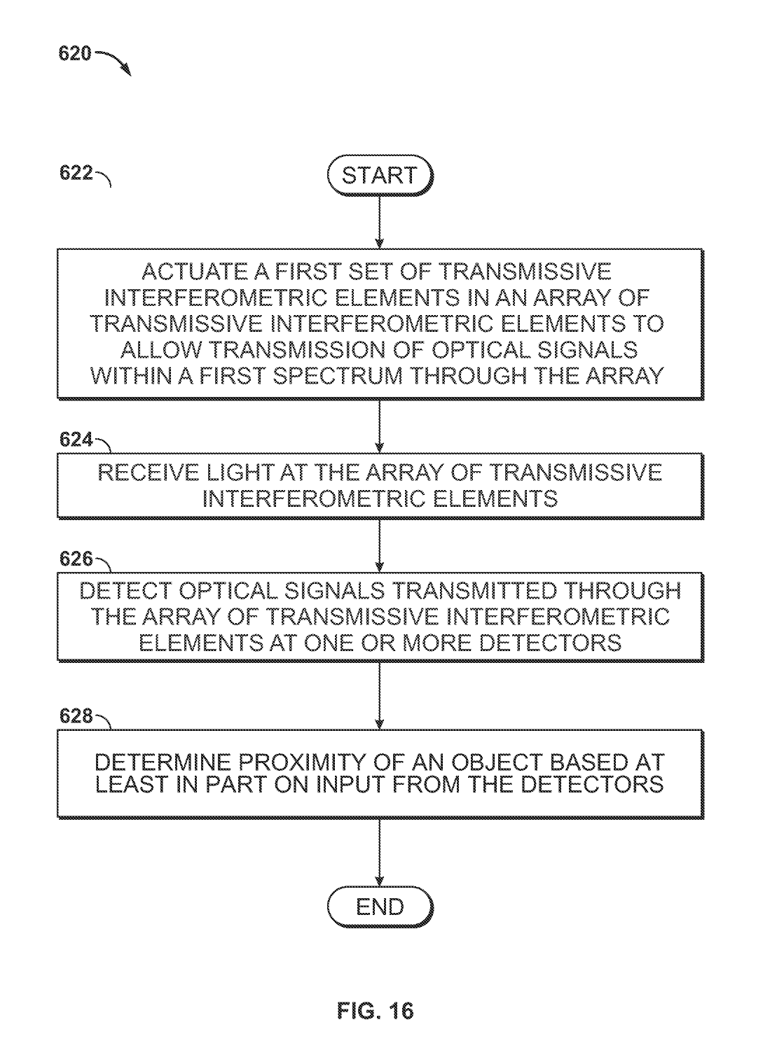

With reference now to FIG. 16, certain stages in one implementation of a process 620 for sensing proximity of an object are illustrated. The process 620 begins at block 622 with actuating one or more transmissive interferometric elements to allow transmission of optical signals within a first transmission spectrum through the elements. The process 620 then moves to block 624 in which light is received at the one or more transmissive interferometric elements. The light can be ambient or directed light reflected off an object, such as a fingertip, near the transmissive elements. The process 620 then moves to block 626 with detecting optical signals that are transmitted through the one or more transmissive interferometric elements at one or more detectors. Then, optionally, at block 628, the proximity of the object can be determined at least in part on input from the one or more detectors. In some implementations, the determining block 628 is performed by a processor in communication with the detectors.

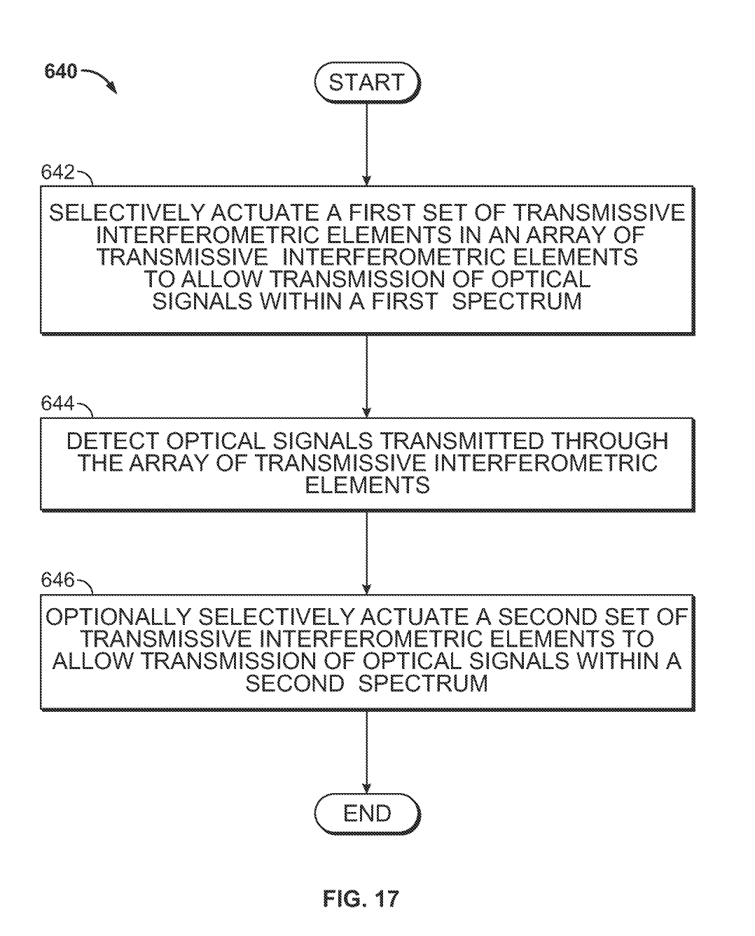

With reference now to FIG. 17, certain stages in an implementation of a process 640 for sensing an optical signal are illustrated. The process 640 begins at block 642 with selectively actuating a first set of transmissive interferometric elements in an array of transmissive interferometric elements to allow transmission of optical signals within a first transmission spectrum through the elements. The process 640 then moves to block 644 in which optical signals that are transmitted through the array of transmissive interferometric elements are detected. Then, at block 646, a second set of transmissive interferometric elements in the array can optionally be selectively actuated to allow transmission of optical signals within a second spectrum through the elements. In some implementations, different transmissive interferometric elements or sets of transmissive interferometric elements can be selectively actuated in a predetermined time sequence. In some implementations, an array of transmissive interferometric elements can be configured to function as a continuously tunable optical filter, operating as a combination digital and analog device. In some implementations, with the ability to distinguish between different parts of the spectrum, an array of transmissive interferometric elements can be configured to allow for different channels of optical data communication from one or more external light sources.

Implementations of the present disclosure can be used in a variety of applications, including sensing the presence, color, and/or intensity of ambient light, scanning and color imaging, detecting and distinguishing objects, detecting the presence or absence of light of a specific wavelength for optical data communication in one or more channels, including but not limited to optical data communication with a display device, optical touch sensing, detecting the optical environment around a device (for example, the quality and intensity of ambient light and position relative to a user's body or to a second device), proximity sensing, including but not limited to sensing the proximity of an object to a device and sensing the position and/or proximity of a mobile device relative to a user or other device.

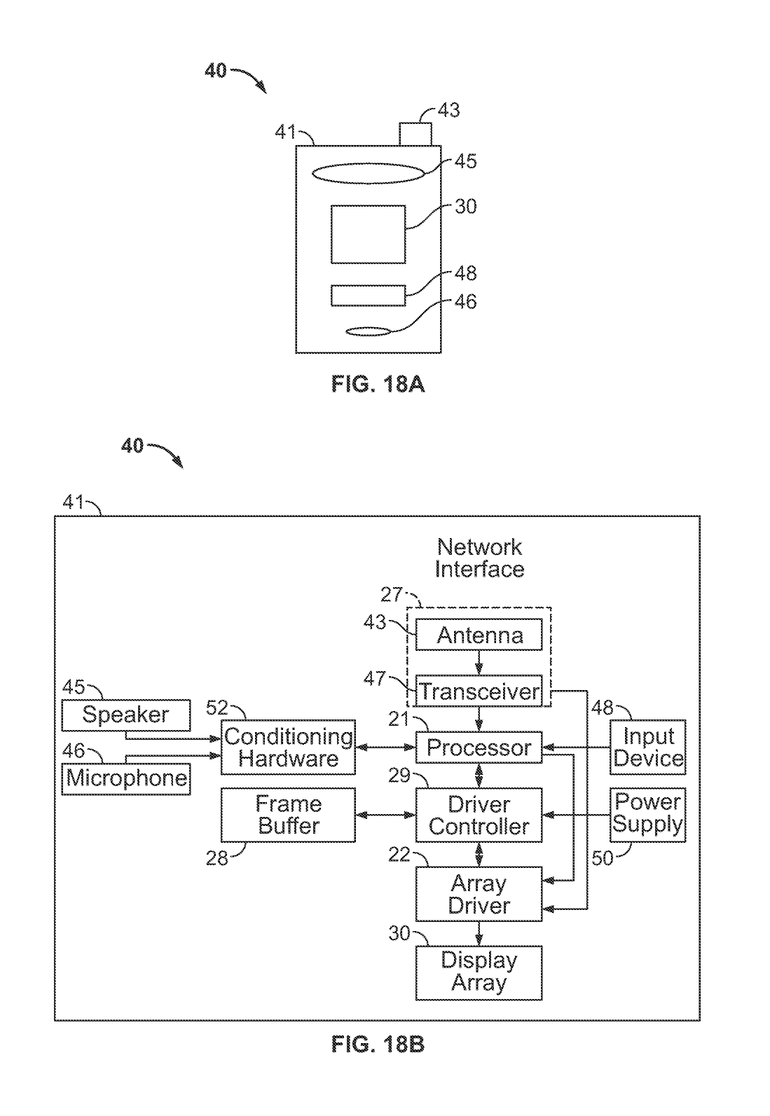

FIGS. 18A and 18B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 18B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3 G or 4 G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 can receive data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

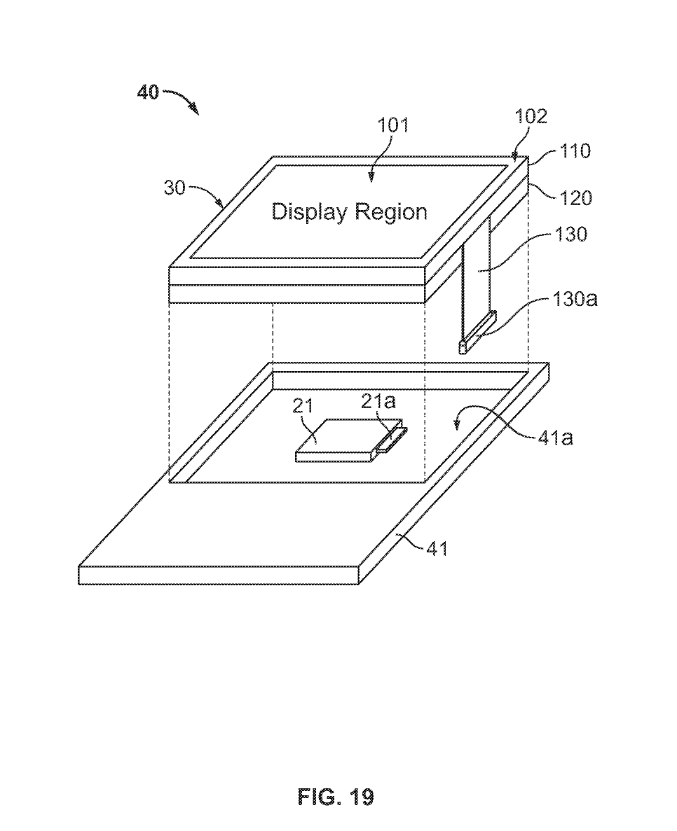

FIG. 19 is an example of a schematic exploded perspective view of the electronic device 40 of FIGS. 18A and 18B according to one implementation. The illustrated electronic device 40 includes a housing 41 that has a recess 41a for a display array 30. The electronic device 40 also can include a processor 21 on the bottom of the recess 41a of the housing 41. The processor 21 can include a connector 21a for data communication with the display array 30. The electronic device 40 also can include other components, at least a portion of which is inside the housing 41. The other components can include, but are not limited to, a networking interface, a driver controller, an input device, a power supply, conditioning hardware, a frame buffer, a speaker, and a microphone, as described earlier in connection with FIG. 18B.

The display array 30 can include a display array assembly 110, a backplate 120, and a flexible electrical cable 130. The display array assembly 110 and the backplate 120 can be attached to each other, using, for example, a sealant.

The display array assembly 110 can include a display region 101 and a peripheral region 102. The peripheral region 102 surrounds the display region 101 when viewed from above the display array assembly 110. The display array assembly 110 also includes an array of display elements positioned and oriented to display images through the display region 101. The display elements can be arranged in a matrix form. In some implementations, each of the display elements can be an interferometric modulator. Also, in some implementations, the term “display element” may be referred to as a “pixel.”

The backplate 120 may cover substantially the entire back surface of the display array assembly 110. The backplate 120 can be formed from, for example, glass, a polymeric material, a metallic material, a ceramic material, a semiconductor material, or a combination of two or more of the foregoing materials, in addition to other similar materials. The backplate 120 can include one or more layers of the same or different materials. The backplate 120 also can include various components at least partially embedded therein or mounted thereon. Examples of such components include, but are not limited to, a driver controller, array drivers (for example, a data driver and a scan driver), routing lines (for example, data lines and gate lines), switching circuits, processors (for example, an image data processing processor) and interconnects.

The flexible electrical cable 130 serves to provide data communication channels between the display array 30 and other components (for example, the processor 21) of the electronic device 40. The flexible electrical cable 130 can extend from one or more components of the display array assembly 110, or from the backplate 120. The flexible electrical cable 130 can include a plurality of conductive wires extending parallel to one another, and a connector 130a that can be connected to the connector 21a of the processor 21 or any other component of the electronic device 40.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An optical sensing device comprising:
a first substrate;
a second substrate opposing the first substrate;
at least one transmissive element formed on the first substrate, the transmissive element being actuatable to allow or prevent passage of optical signals within at least a first transmission spectrum through to the second substrate; and
at least one optical detector formed on the second substrate, the optical detector positioned to detect optical signals passed through the transmissive element.

2. The sensing device of claim 1, wherein the transmissive element includes a partially transmissive fixed layer and a partially transmissive movable layer.

3. The sensing device of claim 1, wherein the transmissive element is configured to allow passage of optical signals within the first transmission spectrum when the transmissive element is in an unactuated state.

4. The sensing device of claim 1, further comprising a plurality of transmissive elements.

5. The sensing device of claim 4, wherein the plurality of transmissive elements includes at least one transmissive element that is actuatable to allow or prevent passage of optical signals within a second transmission spectrum through to the second substrate.

6. The sensing device of claim 4, wherein the transmissive elements are independently actuatable.

7. The sensing device of claim 4, further comprising a plurality of optical detectors formed on the second substrate.

8. The sensing device of claim 7, wherein each of the optical detectors is configured to receive optical signals passed through a single transmissive element.

9. The sensing device of claim 7, wherein at least one of the optical detectors is configured to receive optical signals passed through more than one of the transmissive elements.

10. The sensing device of claim 4, further comprising an array of reflective elements formed on the first substrate, the array of reflective elements being configured to produce a display.

11. The sensing device of claim 10, wherein each of the reflective elements includes a partially transmissive fixed layer and a reflective movable layer.

12. The sensing device of claim 10, wherein the transmissive elements are dispersed throughout the array of reflective elements.

13. The sensing device of claim 10, wherein the transmissive elements are positioned apart from the array of reflective elements.

14. The sensing device of claim 1, further comprising a processor configured to determine proximity of an object to the sensing device based at least in part upon input from the optical detector.

15. The sensing device of claim 1, further comprising a processor configured to determine the color of an object based at least in part upon input from the optical detector.

16. The sensing device of claim 1, further comprising a light guide disposed on the first substrate.

17. An optical sensing device comprising:
a first substrate;
a second substrate opposing the first substrate;
means for selectively allowing or preventing passage of optical signals within at least a first transmission spectrum through the first substrate toward the second substrate; and
means for detecting the presence or intensity of the first spectrum on the second substrate.

18. The sensing device of claim 17, further comprising means for selectively allowing or preventing passage of optical signals within at least a second transmission spectrum through the first substrate toward the second substrate.

19. The sensing device of claim 17, further comprising means for determining the color of an object based at least in part upon input from the detecting means.

20. The sensing device of claim 17, further comprising means for determining the proximity of an object based at least in part upon input from the detecting means.

21. A method of manufacturing a sensing device, comprising:
forming a transmissive element on a first substrate, the transmissive element being actuatable to allow or prevent passage of optical signals within at least a first transmission spectrum;
separately forming an optical detector on a second substrate; and
operatively coupling the first substrate and the second substrate so that optical signals passed through the transmissive element are detectable by the optical detector.

22. The method of claim 21, wherein the transmissive element is configured to transmit optical signals within the visible spectrum.

23. The method of claim 22, wherein the first transmission spectrum corresponds to a first color.

24. The method of claim 21, further comprising forming a plurality of transmissive elements on the first substrate.

25. The method of claim 24, wherein the plurality of transmissive elements includes at least one transmissive element that is actuatable to allow or prevent passage of optical signals within a second transmission spectrum.

26. The method of claim 25, wherein the second transmission spectrum corresponds to a second color.

27. The method of claim 24, further comprising forming a plurality of reflective elements on the first substrate.

28. The method of claim 27, wherein the plurality of transmissive elements are dispersed throughout an array of the reflective elements.

29. The method of claim 27, wherein the plurality of transmissive elements are positioned apart from the plurality of reflective elements.

30. The method of claim 21, wherein forming the transmissive element includes forming a first surface being partially reflective and partially transmissive and a second surface being partially reflective and partially transmissive, the second surface being movable towards the first surface in response to an applied voltage.

31. The method of claim 21, further comprising forming a plurality of the optical detectors on the second substrate.

32. The method of claim 31, further comprising forming circuitry on the second substrate connecting the plurality of optical detectors.

33. The method of claim 32, further comprising connecting the circuitry to a processor, the processor configured to receive and process input from the detectors.

34. The method of claim 21, further comprising testing the optical detector before operatively coupling the first and second substrate.

35. A method of sensing an optical signal, the method comprising:
actuating a first set of transmissive elements in an array of transmissive elements to allow transmission of optical signals within a first spectrum through the array;
receiving light at the array of transmissive elements; and
detecting optical signals transmitted through the array of transmissive elements at one or more detectors.

36. The method of claim 35, further comprising determining the proximity of an object based at least in part on input from the one or more detectors.

37. The method of claim 35, further comprising determining the color of at least a portion of an object based at least in part on input from the one or more detectors.

38. The method of claim 35, wherein the first set of transmissive elements includes elements configured to allow passage of at least two different spectra.

39. The method of claim 35, further comprising actuating a second set of the transmissive elements to allow transmission of optical signals within a second spectrum through the array.

40. A computer readable storage medium comprising instructions that, when executed, cause a processor to perform a method, the method comprising:
actuating a first set of transmissive elements in an array of transmissive elements to allow transmission of optical signals within a first spectrum through the array;
receiving light at the array of transmissive elements; and
detecting optical signals transmitted through the array of transmissive elements.

41. The computer readable storage medium of claim 40, wherein the method further comprises detecting a signal passed through each transmissive element at an individual detector.

42. The computer readable storage medium of claim 41, wherein the method further comprises detecting signals passed through a plurality of transmissive elements at an individual detector.
